(19) United States
(12) Patent Application Publication
(10) Pub. No.: US 2026/0147250 A1
(43) Pub. Date: May 28, 2026

(54) FRONT PLANE LAMINATE INCLUDING POLYURETHANE TOP FILM

(71) Applicant: E INK CORPORATION, Billerica, MA (US)

(72) Inventors: Peter J. VALIANATOS, Manchester by the Sea, MA (US); Jennifer B. LAMPRON, Newton, MA (US); Eric J. DUCHAINE, East Hampstead, NH (US); Kevin R. MONEY, North Billerica, MA (US)

(21) Appl. No.: 19/395,182

(22) Filed: Nov. 20, 2025

Related U.S. Application Data
(60) Provisional application No. 63/723,823, filed on Nov. 22, 2024.

(51) Int. Cl. G02F 1/16755; G02F 1/167

(52) U.S. Cl. CPC G02F 1/16755; G02F 1/167; G02F 2202/022

(57) ABSTRACT

Electro-optic (especially electrophoretic) front plane laminates (FPLs) that include a top layer of light-transmissive polyurethane and displays that include a top layer of light-transmissive polyurethane. Because the FPLs and displays are flexible, they can be easily unrolled, and in some instances cut, at the point of installation and then easily incorporated into a surface, such as a floor, or the body of a vehicle. The front plane laminates (FPLs) and displays that include a top layer of light-transmissive polyurethane may be subsequently overcoated with a polyurethane sealant, polyurethane hard coat, polyurethane dispersion, or polyurethane film.

### REFERENCE TO RELATED APPLICATIONS

This application claims priority to U.S. Provisional Patent Application No. 63/723,823, filed Nov. 22, 2024. All patents and publications mentioned below are herein incorporated by reference in their entireties.

### BACKGROUND OF INVENTION

The present invention relates to front plane laminates and displays that can be used to incorporate electro-optic display layers, such as electrophoretic display layers, into everyday objects. In particular, the present invention helps to improve the durability and appearance of an object that would typically include a protective polyurethane coating, such as a hardwood floor, door, sporting equipment, or a protective coating on a vehicle, such as an automobile, aircraft, watercraft, etc.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some

other types of electro-optic displays. This type of display is properly called “multi-stable” rather than bistable, although for convenience the term “bistable” may be used herein to cover both bistable and multi-stable displays.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,180,649; 7,226,550; 7,230,750; 7,230,751; 7,236,290; 7,247,379; 7,277,218; 7,286,279; 7,312,916; 7,375,875; 7,382,514; 7,390,901; 7,411,720; 7,473,782; 7,532,388; 7,532,389; 7,572,394; 7,576,904; 7,580,180; 7,679,814; 7,746,544; 7,767,112; 7,848,006; 7,903,319; 7,951,938; 8,018,640; 8,115,729; 8,199,395; 8,257,614; 8,270,064; 8,305,341; 8,361,620; 8,363,306; 8,390,918; 8,582,196; 8,593,718; 8,654,436; 8,902,491; 8,961,831; 9,052,564; 9,114,663; 9,158,174; 9,341,915; 9,348,193; 9,361,836; 9,366,935; 9,372,380; 9,382,427; 9,423,666; 9,428,649; 9,552,780; 9,557,623; 9,664,978; 9,670,367; 9,671,667; 9,688,859; 9,726,957; 9,732,231; 9,752,034; 9,765,015; 9,778,535; 9,778,537; 9,778,538; 9,835,926; 9,864,253; 9,953,588; 9,995,987; 10,025,157; 10,031,394; 10,040,954; 10,061,123; 10,062,337; 10,431,168; 10,444,590; and 10,514,583; and U.S. Patent Applications Publication Nos. 2003/0048522; 2003/0151029; 2003/0164480; 2004/0030125; 2005/0012980; 2009/0009852; 2009/0206499; 2009/0225398; 2010/0148385; 2011/0217639; 2012/0049125; 2013/0161565; 2013/0193385; 2013/0244149; 2014/0011913; 2014/0078024; 2014/0078573; 2014/0078576; 2014/0104674; 2014/0231728; 2015/0177590; 2015/0185509; 2015/0241754; 2015/0301425; and 2016/0170106;
(b) Capsules, binders and encapsulation processes; see for example U.S. Pat. Nos. 5,930,026; 6,067,185; 6,130,774; 6,172,798; 6,249,271; 6,327,072; 6,392,785; 6,392,786; 6,459,418; 6,839,158; 6,866,760; 6,922,276; 6,958,848; 6,987,603; 7,061,663; 7,071,913; 7,079,305; 7,109,968; 7,110,164; 7,184,197; 7,202,991; 7,242,513; 7,304,634; 7,339,715; 7,391,555; 7,411,719; 7,477,444; 7,561,324; 7,848,007; 7,910,175; 7,952,790; 7,955,532; 8,035,886; 8,129,655; 8,446,664; and 9,005,494; and U.S. Patent Applications Publication Nos. 2005/0156340; 2007/0091417; 2008/0130092; 2009/0122389; and 2011/0286081;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,833,177; 6,850,355; 6,865,012; 6,870,662; 6,885,495; 6,906,779; 6,930,818; 6,933,098; 6,947,202; 6,987,605; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,582,197; 8,891,156; 9,279,906; 9,291,872; 9,388,307; 9,436,057; 9,436,058; 9,470,917; 9,919,553; and 10,401,668; and U.S. Patent Applications Publication Nos. 2003/0175480; 2003/0175481; 2003/0179437; 2003/0203101; 2014/0050814; and 2016/0059442;
(d) Methods for filling and sealing microcells; see for example U.S. Pat. Nos. 6,545,797; 6,751,008; 6,788,449; 6,831,770; 6,833,943; 6,859,302; 6,867,898; 6,914,714; 6,972,893; 7,005,468; 7,046,228; 7,052,571; 7,144,942; 7,166,182; 7,374,634; 7,385,751; 7,408,696; 7,522,332; 7,557,981; 7,560,004; 7,564,614; 7,572,491; 7,616,374; 7,684,108; 7,715,087; 7,715,088; 8,179,589; 8,361,356; 8,520,292; 8,625,188; 8,830,561; 9,081,250; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,112,114; 7,158,282; 7,236,292; 7,443,571; 7,513,813; 7,561,324; 7,636,191; 7,649,666; 7,728,811; 7,729,039; 7,791,782; 7,826,129; 7,839,564; 7,843,621; 7,843,624; 8,034,209; 8,068,272; 8,077,381; 8,177,942; 8,390,301; 8,482,835; 8,786,929; 8,830,553; 8,854,721; 9,075,280; 9,238,340; 9,470,950; 9,554,495; 9,563,099; 9,733,540; 9,778,536; 9,835,925; 10,444,591; and 10,466,564; and U.S. Patent Applications Publication Nos. 2007/0237962; 2009/0168067; and 2011/0164301;
(f) Backplanes, adhesive layers and other auxiliary layers and methods used in displays; see for example U.S. Pat. Nos. D485,294; 6,124,851; 6,130,773; 6,177,921; 6,232,950; 6,252,564; 6,312,304; 6,312,971; 6,376,828; 6,392,786; 6,413,790; 6,422,687; 6,445,374; 6,480,182; 6,498,114; 6,506,438; 6,518,949; 6,521,489; 6,535,197; 6,545,291; 6,639,578; 6,657,772; 6,664,944; 6,680,725; 6,683,333; 6,724,519; 6,750,473; 6,816,147; 6,819,471; 6,825,068; 6,831,769; 6,842,167; 6,842,279; 6,842,657; 6,865,010; 6,873,452; 6,909,532; 6,967,640; 6,980,196; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,280,094; 7,301,693; 7,304,780; 7,327,346; 7,327,511; 7,347,957; 7,349,148; 7,352,353; 7,365,394; 7,365,733; 7,382,363; 7,388,572; 7,401,758; 7,442,587; 7,492,497; 7,535,624; 7,551,346; 7,554,712; 7,560,004; 7,583,427; 7,598,173; 7,605,799; 7,636,191; 7,649,674; 7,667,886; 7,672,040; 7,688,497; 7,733,335; 7,785,988; 7,830,592; 7,839,564; 7,843,626; 7,859,637; 7,880,958; 7,893,435; 7,898,717; 7,905,977; 7,957,053; 7,986,450; 8,009,344; 8,027,081; 8,049,947; 8,072,675; 8,077,141; 8,089,453; 8,120,836; 8,159,636; 8,208,193; 8,237,892; 8,238,021; 8,362,488; 8,373,211; 8,389,381; 8,395,836; 8,437,069; 8,441,414; 8,456,589; 8,498,042; 8,514,168; 8,547,628; 8,576,162; 8,610,988; 8,714,780; 8,728,266; 8,743,077; 8,754,859; 8,797,258; 8,797,633; 8,797,636; 8,830,560; 8,891,155; 8,969,886; 9,147,364; 9,025,234; 9,025,238; 9,030,374; 9,140,952; 9,152,003; 9,152,004; 9,201,279; 9,223,164; 9,285,648; 9,310,661; 9,419,024; 9,454,057; 9,529,240; 9,620,066; 9,632,373; 9,632,389; 9,666,142; 9,671,635; 9,715,155; 9,777,201; 9,778,500; 9,841,653; 9,897,891; 9,910,337; 9,921,422; 9,964,831; 10,036,930; 10,037,735; 10,048,563; 10,048,564; 10,190,743; 10,324,577; 10,365,533; 10,372,008; 10,429,715; 10,446,585; 10,466,564; 10,466,565; 10,495,940; 10,495,941; 10,503,041; and 10,509,294; and U.S. Patent Applications Publication Nos. 2002/0060321; 2004/0085619; 2004/0105036; 2005/0122306; 2005/0122563; 2006/0255322; 2007/0052757; 2009/0122389; 2009/0315044; 2010/0177396; 2011/0140744; 2011/0187683; 2011/0292319; 2014/0078024; 2014/0192000; 2014/0210701; 2014/0368753; 2015/0378235; and 2016/0077375; and International Application Publication No. WO 00/38000; European Patents Nos. 1,099,207 B1 and 1,145,072 B1;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; 9,423,666; 9,436,056; 9,459,510; 9,513,527; 9,541,814; 9,552,780; 9,640,119; 9,646,547; 9,671,668; 9,697,778; 9,726,959; 9,740,076; 9,759,981; 9,761,181; 9,778,538; 9,779,670; 9,779,671; 9,812,073; 9,829,764; 9,921,451; 9,922,603; 9,989,829; 10,032,419; 10,036,929; 10,036,931; 10,332,435; 10,339,876; 10,353,266; 10,366,647; 10,372,010; 10,380,931; 10,380,955; 10,431,168; 10,444,592; 10,467,984; 10,475,399; 10,509,293; and 10,514,583; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2015/0103394; 2015/0118390; 2015/0124345; 2015/0268531; 2015/0301246; 2016/0026062; 2016/0048054; and 2016/0116818;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; 9,412,314; 9,424,800; 9,460,666; 9,495,918; 9,501,981; 9,513,743; 9,514,667; 9,530,363; 9,542,895; 9,564,088; 9,612,502; 9,620,048; 9,620,067; 9,672,766; 9,721,495; 9,779,670; 9,881,564; 9,881,565; 9,886,886; 9,928,810; 9,966,018; 9,996,195; 10,002,575; 10,037,089; 10,380,954; 10,388,233; 10,475,396; and 10,504,457; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0322721; 2010/0194733; 2010/0194789; 2010/0220121; 2010/0265561; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2014/0009817; 2014/0085355; 2014/0204012; 2014/0218277; 2014/0240210; 2014/0253425; 2014/0293398; 2015/0262255; 2015/0262551; 2016/0071465; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; 9,197,704; 9,506,243; 9,880,646; and 10,331,005; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

A related type of electrophoretic display is a so-called “microcell electrophoretic display”. In a microcell electrophoretic display, the charged particles and the suspending fluid are not encapsulated within microcapsules but instead are retained within a plurality of cavities formed within a carrier medium, typically a polymeric film. See, for example, International Application Publication No. WO 02/01281, and published US Application No. 2002/0075556, both assigned to SiPix Imaging, Inc.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive.

The aforementioned U.S. Pat. No. 6,982,178 describes a method of assembling a solid electro-optic display (including a particle-based electrophoretic display) which is well adapted for mass production. Essentially, this patent describes a so-called “front plane laminate” (“FPL”) which comprises, in order, a light-transmissive electrically-conductive layer; a layer of electro-optic medium in electrical contact with the electrically-conductive layer; an adhesive layer; and a release sheet. When used in the production of an electro-optic display, the release sheet (substrate) can be removed from the FPL, and the adhesive layer used to affix the FPL to a backplane conductor, which can be a simple metal foil or carbon, or it can be complex microcircuitry, such as an active-matrix pixel electrode backplane. When a voltage is provided between the backplane and the light-transmissive electrically-conductive layer, the optical state of the electro-optic medium will change. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will be normally be viewed through the electrically-conductive layer and adjacent substrate (if present). The substrate will be typically be a polymeric film, and will normally have a thickness in the range of about 1 to about 25 mil (25 to 634 μm), preferably about 2 to about 10 mil (51 to 254 μm). The electrically-conductive layer is conveniently a thin metal layer of, for example, aluminum or ITO, or may be a conductive polymer. Poly(ethylene terephthalate) (PET) films coated with aluminum or ITO are available commercially from Saint Gobain (Courbevoie, France).

The term “impulse” is used herein in its conventional meaning of the integral of voltage with respect to time. However, some bistable electro-optic media act as charge transducers, and with such media an alternative definition of impulse, namely the integral of current over time (which is equal to the total charge applied) may be used. The appropriate definition of impulse should be used, depending on whether the medium acts as a voltage-time impulse transducer or a charge impulse transducer. The term “waveform” will be used to denote the entire voltage against time curve used to effect the transition from one specific initial gray level to a specific final gray level. Typically, such a waveform will comprise a plurality of waveform elements; where these elements are essentially rectangular (i.e., where a given element comprises application of a constant voltage for a period of time); the elements may be called “pulses” or “drive pulses”. The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible, as described in several of the aforementioned MEDEOD applications, to use more than one drive scheme simultaneously in different areas of the same display, and a set of drive schemes used in this manner may be referred to as “a set of simultaneous drive schemes.”

A further complication in driving electrophoretic displays is the need for so-called “DC balance”. As discussed in the aforementioned U.S. Pat. Nos. 6,531,997 and 6,504,524, problems may be encountered, and the working lifetime of a display reduced, if the method used to drive the display does not result in zero, or near zero, net time-averaged applied electric field across the electro-optic medium. A drive method which does result in zero net time-averaged applied electric field across the electro-optic medium is conveniently referred to a “direct current balanced” or “DC balanced”.

The aforementioned U.S. Pat. No. 6,982,178 also describes the importance of protecting the electro-optic medium from environmental contaminants, since some electro-optic media are sensitive to humidity and ultra-violet radiation, and most such media are susceptible to mechanical damage. This published application illustrates, in FIG. 10, a process in which a moisture barrier is laminated over a front plane laminate in the same lamination operation by which the front plane laminate is laminated to a backplane; such a protective moisture barrier can protect the electro-optic medium against ingress of moisture, other liquids, and some gases. However, even with such a moisture barrier, the edge of the electro-optic medium is still exposed to the environment, and this published application teaches that it is also advisable for the display to include an edge seal, which serves to prevent the ingress of moisture and other contaminants around the outer edges of the display. Various types of edge seals are illustrated in FIGS. 11-17 of U.S. Pat. No. 6,982,178. This edge seal can be composed of metallized foil or other barrier foil adhered over the edge of the FPL, dispensed sealants (thermal, chemical, and/or radiation cured), polyisobutylene or acrylate-based sealants, and so on. It has been found that hybrid radiation and thermal cure sealants (i.e. UV curable with thermal post-bake) offer certain advantages to display system performance. Threebond 30Y-491 material (from Threebond Corporation, Cincinnati, OH) is especially preferred because of its favorable water vapor barrier properties, low viscosity at elevated temperature for easy dispensing of the edge seal material, good wetting characteristics, and manageable curing properties. Those skilled in the art and familiar with advanced sealants will be able to identify other sealants that offer comparable performance.

On the upper surface of the backplane are disposed a layer of lamination adhesive, a layer of an electro-optic medium, a front electrode and a front substrate; the front electrode and front substrate are both conveniently formed from an indium-tin-oxide coated polymeric film, and as already noted such coated films are readily available commercially. The lamination adhesive layer, the electro-optic layer, the front electrode and front substrate are all derived from a front plane laminate which has been laminated to the backplane. One portion of the front electrode and front substrate extend beyond the electro-optic layer, and in the extended portion of the front electrode and front substrate, a conductive via formed from silver ink electrically connects the front electrode to circuitry provided on the backplane, while an adhesive layer secures the extended portion of the front electrode to the backplane.

In some embodiments is known to cover the FPL with a succession of a first layer of optically clear adhesive, a moisture barrier, a second layer of optically clear adhesive and a further, relatively thick protective film (such as a polycarbonate) provided on its exposed surface with an anti-glare coating. The protective film acts to block ultra-violet radiation from reaching the electro-optic layer, and also prevents atmospheric moisture or other contaminants reaching this layer.

In order to form a complete seal around the electro-optic layer, the barrier film, the second layer of optically clear adhesive and the protective film are all made larger in both dimensions than the front substrate, so that these layers have peripheral portions which extend or “overhang” the outer edges of the front substrate. To complete the sealing of the electro-optic layer, a curable edge sealing material is injected, typically via a needle dispenser, into the area of the overhang, and cured to form an edge seal completely surrounding the electro-optic layer.

Once completed, such displays and front plane laminates can be incorporated into common objects because they are relatively thin, lightweight and only require a small amount of power to change optical states. In some instances, a user will provide a back electrode, such as a metal foil, and attach the front plane laminate to the back electrode. In some instances, a user will purchase a front plane laminate with a backplane (i.e., a display) and affix the full display stack to the object. For example, electrophoretic films from E Ink Corporation have been incorporated into automobiles and furniture. However, incorporating such films into surfaces typically requires an additional protective layer of polycarbonate or glass to increase durability. It would be beneficial to provide a front plane laminate that easily integrates with protective layers that are more economical and can be, for example, sprayed, rolled, or brushed on, such as polyurethanes. Such polyurethanes might include floor coatings such as for a hardwood court or concrete, automotive clear coats, and recreational equipment such as skis, racquets, surf boards, etc. Such coatings make it easier to clean the surface and also provide some amount of dent protection through hardness and some absorption of shock. In some instances, the coatings are self-healing in that, if they are cut or nicked, with time the polyurethane will flow to fill the cuts or nicks.

### SUMMARY OF THE INVENTION

In a first aspect, a front plane laminate comprising a layer of light-transmissive polyurethane, a clear conductor, an electro-optic layer including an electrophoretic medium, and a substrate. In one embodiment, the substrate comprises a second layer of light-transmissive polyurethane. In one embodiment, the front plane laminate further comprises a UV protection barrier between the layer of light-transmissive polyurethane and the clear conductor. In one embodiment, the front plane laminate further comprises a UV protection layer between the layer of light-transmissive polyurethane and the clear conductor. In one embodiment, the front plane laminate further comprises a first moisture barrier between the layer of light-transmissive polyurethane and the clear conductor. In one embodiment, the front plane laminate further comprises a second moisture barrier between the conductor and the substrate. In one embodiment, the clear conductor comprises indium tin oxide [ITO], poly(3,4-ethylenedioxythiophene) [PEDOT], nanotubes, graphene, metal threads, or metal grid. In one embodiment, the front plane laminate further comprises one or more layers of adhesive between the layer of light-transmissive polyurethane and the substrate. In one embodiment, the front plane laminate is combined with a backing layer below the substrate. In one embodiment, the backing layer is coupled to the front plane laminate with a pressure sensitive adhesive to allow the backing layer to be removed from the front plane laminate so that the front plane laminate can be affixed to a surface. In one embodiment, the outer layer of light-transmissive polyurethane is a thermoplastic polyurethane (TPU). In one embodiment, the outer layer of light-transmissive polyurethane is between 1 mm and 100 μm in thickness.

In another aspect a display comprising an outer layer of light-transmissive polyurethane. In one embodiment, the display comprising an outer layer of light-transmissive polyurethane includes from top to bottom: a layer of light-transmissive polyurethane, a clear conductor, an electro-optic layer including an electrophoretic medium, a conductor, and a substrate. In one embodiment, the substrate comprises a second layer of light-transmissive polyurethane. In one embodiment, the display further comprises a UV protection barrier between the layer of light-transmissive polyurethane and the clear conductor. In one embodiment, the display further comprises a UV protection layer between the layer of light-transmissive polyurethane and the clear conductor. In one embodiment, the display further comprises a first moisture barrier between the layer of light-transmissive polyurethane and the clear conductor. In one embodiment, the display further comprises a second moisture barrier between the conductor and the substrate. In one embodiment, the clear conductor comprises indium tin oxide [ITO], poly(3,4-ethylenedioxythiophene) [PEDOT], nanotubes, graphene, metal threads, or metal grid. In one embodiment, the display further comprises one or more layers of adhesive between the layer of light-transmissive polyurethane and the substrate. In one embodiment, the display is combined with a backing layer below the substrate. In one embodiment, the backing layer is coupled to the display with a pressure sensitive adhesive to allow the backing layer to be removed from the display so that the display can be affixed to a surface. In one embodiment, the outer layer of light-transmissive polyurethane is a thermoplastic polyurethane (TPU). In one embodiment, the outer layer of light-transmissive polyurethane is between 1 mm and 100 μm in thickness.

In another aspect, a method of incorporating an electro-optic medium into a surface comprising providing a display comprising an outer layer of light-transmissive polyurethane, affixing the display comprising an outer layer of light-transmissive polyurethane to the surface wherein the display comprises an outer layer of light-transmissive polyurethane does not cover the entire surface, and coating the surface and the display comprising an outer layer of light-transmissive polyurethane with a polyurethane. In one embodiment, the display comprises in order from top to bottom: a layer of light-transmissive polyurethane, a clear conductor, an electro-optic layer including an electrophoretic medium, a conductor, and a substrate. In one embodiment, the surface comprises a floor, a wall, a window, a door, a countertop, a body panel of a vehicle, or recreational equipment. In one embodiment, coating comprises covering the surface and the display comprising an outer layer of light-transmissive polyurethane with a polyurethane dispersion and curing the polyurethane dispersion. In one embodiment, coating comprises spraying, rolling, or brushing the polyurethane dispersion.

### BRIEF DESCRIPTION OF DRAWINGS

FIG. 1 depicts a simple front plane laminate including a layer of electro-optic material (i.e., electrophoretic medium), a clear conductor, a backing layer and a top layer of light-transmissive polyurethane (i.e., a thermoplastic polyurethane (TPU)).

FIG. 2 depicts a full stack of an electrophoretic display including a top layer of light-transmissive polyurethane as could be incorporated into an automobile body panel or some other outdoor application requiring moisture barriers and UV protection.

FIG. 3 depicts an alternative embodiment of an electrophoretic display wherein the top clear conductor is directly coupled to the top layer of light-transmissive polyurethane.

FIG. 4 depicts a full stack of an electrophoretic display including a top layer of light-transmissive polyurethane as could be incorporated into a surface that would not be exposed to UV light, such as an interior door or a floor, i.e., the floor of a gymnasium.

FIG. 5 depicts a display including an encapsulated electrophoretic medium that is contained in microcapsules and held in a binder layer between conductive layers. In the embodiment of FIG. 5, the conductors are bonded directly to polyurethane layers.

FIG. 6 depicts a display including an encapsulated electrophoretic medium that is contained in microcells that are filled and sealed and disposed between conductive layers. In the embodiment of FIG. 6, the conductors are bonded directly to polyurethane layers.

FIGS. 7A and 7B illustrate an application of a display of the invention being integrated into the floor of a hardwood basketball court. The electro-optic properties of the display allow the free throw lane (a.k.a. “paint”) to be switched depending upon the colors of the home team or for special occasions, such as cancer awareness. Because the outer polyurethane layer of the front plane is compatible with the polyurethane dispersion that is used to protect the hardwood, the integration is seamless and looks and plays like normal court line paint.

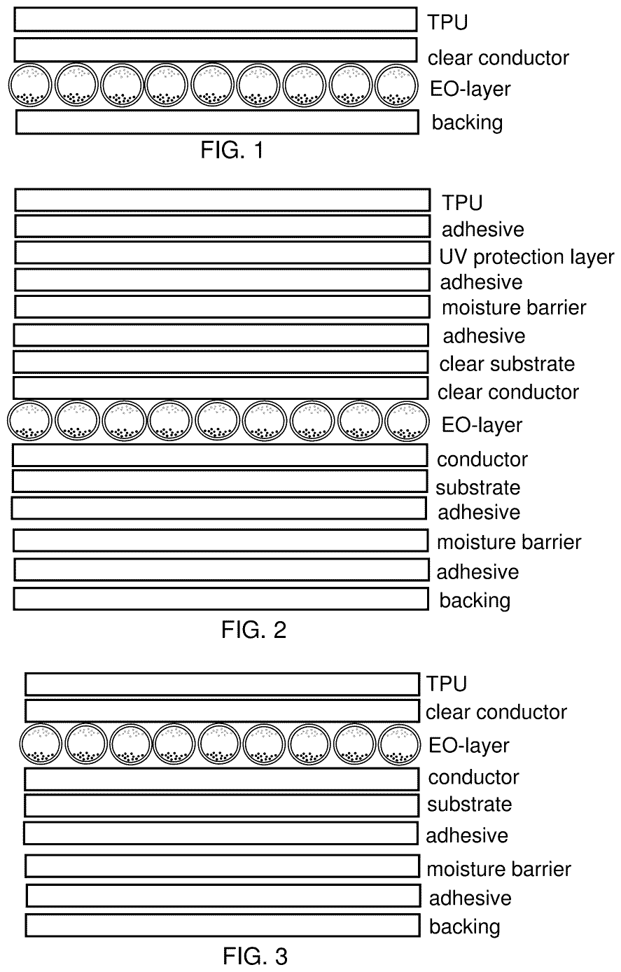

It should be stressed that all the accompanying drawings are schematic and not to scale. In particular, for ease of illustration, the thicknesses of the various layers in the drawings do not correspond to their actual thicknesses. In all the drawings, the thicknesses of the various layers are greatly exaggerated relative to their lateral dimensions. Additionally, as depicted in FIGS. 1-6, all of the layers are separated for ease of distinguishing the separate layers in the drawings. In reality, the layers are in contact with each other, or adjacent to each other with an intervening adhesive layer.

### DETAILED DESCRIPTION

Described herein are electro-optic front plane laminates (FPLs) including a top layer of light-transmissive polyurethane and displays including a top layer of light-transmissive polyurethane. Because the front plane laminates and displays are produced with a roll-to-roll process and are flexible, they can be easily unrolled, and in some instances cut, at the point of installation and then easily incorporated into a surface, such as a floor or the body of a vehicle, where they will be overcoated with a polyurethane sealant, hard coat, or film.

Front plane laminates and displays including a light-transmissive polyurethane layer represent an improvement over state-of-the-art electro-optic front plane laminates and displays, e.g., electrophoretic front plane laminates and displays because those including polyurethanes are more easily incorporated into products and they are less likely to delaminate from protective overcoats which are typically used to protect a larger surface, such as a floor or a body panel of an automobile. Furthermore, it has been found that with repeated impacts and thermocycling, electro-optic displays of the type described herein begin to detach from the overcoat which introduces new failure pathways such as water ingress, air bubbles, color inconsistency, and electrical shorts, among other potential failures.

The simplest form of a front plane laminate including a light-transmissive polyurethane layer is shown in FIG. 1. It includes (from top, i.e., viewing surface, to bottom) a film of light-transmissive polyurethane, a clear conductor, an electro-optic layer, and a backing, which may be removable from the electro-optic layer. The backing may be any durable thin film polymer, such as a polyester, polystyrene, polyvinyl, or acrylic, or it may even be butcher paper or the like to the extent that it is meant to be temporary. The light-transmissive polyurethane film may be a thermoplastic polyurethane (TPU) such as sold by Lubrizol under the tradename ESTANE®. The thermoplastic polyurethane may be separately coated onto a substrate and transferred or it may be purchased as a film from, e.g., 3M (Minneapolis, MN). The light-transmissive polyurethane typically has a thickness of 2-8 mils, i.e., 50 to 250 μm thick, however it could be up to 1 mm thick depending upon the application. The clear conductor in some instances will be directly contacting the light-transmissive polyurethane, however in other instances the clear conductor will be provided on a clear substrate, such as polyethylene terephthalate (PET) that will be coupled to the light-transmissive polyurethane, i.e., with an adhesive, such as a thermal cure pressure sensitive adhesive. The clear conductor may indium tin oxide [ITO] or another light-transmissive conductive ceramic, poly(3,4-ethylenedioxythiophene) [PEDOT], nanotubes, graphene, metal threads, metal grids, or some combination thereof. In some instances, the ITO may be vapor deposited directly onto the light-transmissive polyurethane film and then used to build up the FPL as described in the background section above. In many embodiments a separate adhesive layer is included between the electro-optic layer and the backing.

Alternative embodiments of front plane laminates including an outer light-transmissive polyurethane layer will now be described with reference to the accompanying drawings. In all cases, the electrophoretic layer may be an encapsulated electrophoretic layer, a polymer-dispersed electrophoretic layer, or any of the other types of electro-optic layer discussed above. The electrophoretic layer may be contained in microcells defined by microembossing a polymer, such as an acrylate, filling the microcells with an electrophoretic medium, and then sealing the microcells to contain the electrophoretic medium. A front plane laminate may contain one or two (or more) lamination adhesive layers to attach the layers of the electrophoretic display to each other or to the front substrate and/or the backplane. (When a back electrode, i.e., backplane is included, the laminate is properly a “display” however, the embodiments described herein are contemplated to be made and sold with, and without, a back electrode. Additionally, all of the front plane laminates described herein are contemplated to include both top and bottom pressure-sensitive adhesives and release layers to allow an end user to couple the FPL to a surface or to another film.)

The type of electrophoretic material that is incorporated into the disclosed electrophoretic displays is not limited. For example, electrophoretic media of the invention may include two oppositely charged particles that have different optical characteristics, for example black and white. However, the colors incorporated into the electrophoretic medium are not limited and may include, for example, red, orange, yellow, green, blue, violet, brown, pink, magenta, and cyan, among others. The electrophoretic media may include three or more different sets of electrophoretic materials, such as described in U.S. Pat. Nos. 9,921,451, 9,812,073, and 11,868,020, all of which are incorporated by reference in their entireties.

A more complete display including an outer layer of light-transmissive polyurethane, as would be used in automotive applications, is shown in FIG. 2. Such displays are typically flexible and can be rolled and unrolled for integration into surfaces. The display of FIG. 2 includes a more traditional “Prism” construction of an encapsulated electrophoretic medium (i.e., charged electrophoretic particles dispersed in a non-polar solvent, contained in microcapsules, and held in a binder layer) between two layers of clear conductor coupled to a clear substrate, such as PET-ITO available commercially in rolls from Saint Gobain. The Prism material is moisture barriered on both sides to control moisture egress. As discussed in U.S. Pat. Nos. 6,982,178 and 7,110,164 and Patent Publication No 2004/0155857, one preferred form of front substrate for electro-optic displays comprises a thin layer of ITO on PET, such coated films being readily available commercially. In such a front substrate, the ITO layer serves as a moisture barrier material, but in practice commercial PET/ITO inevitably suffers from pinholes and cracks, through which moisture and other contaminants can penetrate to the electro-optic material.

To increase the sealing properties of such a PET/ITO or similar front substrate, it is desirable to laminate a redundant moisture barrier layer on to the front and back substrates, this redundant moisture barrier layer being formed of a homopolymer (for example, polychlorotrifluoroethylene, available from Honeywell Corporation under the Registered Trade Mark “ACLAR”), or a sputtered ceramic (for example AlOₓ, available from Toppan Printing Company under the trade name Toppan GX Film). The redundant barrier layer should be thin to provide a flexible display, ideally about 12 μm, but could be as thick as 5 mil (127 μm) if sufficient flexibility is still available. Where an adhesive layer is required to attach the redundant barrier to the front substrate, the adhesive layer should be transparent, colorless, thin, flexible, have low creep (when the display is flexed or rolled), and be durable at all temperatures within the operating range of the display. Certain cross-linked polyurethanes and polyacrylates can be used as such adhesives. The optical properties of the back moisture barrier are not as critical because a user will only see the (top) viewing surface.

In addition to the moisture barrier(s), an FPL or display of the type used in outdoor applications will typically also include a UV protection layer, which may be a separate film or a supplied coating. For example, such UV protection layers can include protection layers from 3M such as FTB3-UV-50, which is an engineered polyester that additionally provides moisture and oxygen barrier properties. The UV protection layer may also include an adhesive layer with additives that decrease UV damage, such as trace amounts of titanium dioxide, zinc oxide, oxybenzone, etc. In some embodiments, once all of the non-polyurethane layers are assembled, a final layer of light-transmissive polyurethane, i.e., as described above, is added to create a front plane laminate comprising an outer layer of light-transmissive polyurethane.

In many applications, one or more of the protective/barrier layers may be integrated into a single integrated layer, which may include many properties such as clear conductor, clear substrate, moisture barrier, UV protection layer, and one or more layers of adhesive (typically optically-clear adhesive) as needed to produce a thin sheet of material with properties desirous for the application. Additionally, some applications will require an FPL or display that is pre-cut to a specific shape and includes edge seals to better control humidity and oxygen exchange with the electro-optic medium. In other applications, especially where an end user will cut the FPL or display for use, an edge seal is not included. A variety of edge seal methods and compositions are known, such as described in U.S. Patent Publication No. 2022/0334448, which is incorporated by reference herein in its entirety.

In some implementations additional protective layers may be incorporated into the FPL or display. Such layers must address many properties, such as flexibility, cost, and other specialized properties, which often drive the choice of both the polymer and conductive material used in the laminate. Many different flexible, light-transmissive polymer may in principle be used; suitable polymers include PET, PEN, polyesters, polycarbonate, poly(vinylidene chloride) (sold under the Registered Trade Mark “SARAN”), polychlorotrifluoroethylene (sold under the Registered Trade Marks “ACLAR” and “CLARIS”), triacetyl cellulose, the material sold under the Registered Trade Mark “ARTON” by JSR Company, polyethersulfone (PES) and laminates of two or more of these materials. In specialty applications, light-transmissive fluoropolymer may be used. Suitable transparent conductive materials include ITO, PEDOT, organic conductive polymers such as BAYTRON®, carbon nanotubes, and other suitably conducting light transmissive conductors (transmission greater than 60 per cent) having resistivities of less an about 10⁴ ohms/square.

An alternative construction of a display comprising an outer layer of light-transmissive polyurethane is described with respect to FIG. 3. In the embodiment of FIG. 3, the top of the display has been minimized to include only a layer of light-transmissive polyurethane coupled to a clear conductor, such as ITO or PEDOT. The construction of FIG. 3 is preferred for customers who will integrate the display into an existing barrier system, such as a clear coat on an automobile, which may separately include the UV-protection and moisture barriers that are required for the application. In some embodiments, the backing of FIG. 3 is removable, such that the display can be “peeled and stuck” to a surface prior to be integrated into the object. It is understood that that integration may additionally include coupling the clear conductor and the optional (back) conductor to a voltage source to provide the requires electric fields to cause the electro-optic layer to change appearance on demand.

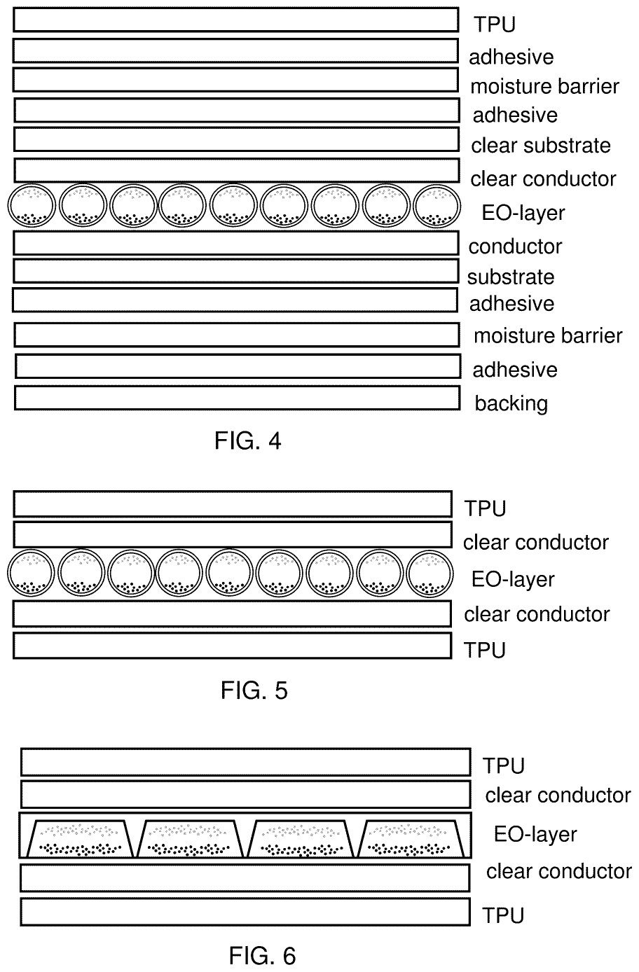

Another embodiment of a display comprising an outer layer of light-transmissive polyurethane is described with respect to FIG. 4. The embodiment of FIG. 4 is suitable for indoor applications where it is not necessary to provide a UV barrier. (In general, removing any layers decreases the cost of the FPL and improves the optical performance because there are fewer interfaces for the ambient light to pass through—each interface tends to increase scattering.) Thus, the embodiment of FIG. 4 is very similar to the embodiment of FIG. 2 except that it does not include the UV protection layer and the associated additional layer(s) of adhesive.

FIGS. 5 and 6 represent the simplified versions of “Prism” type display including clear polyurethane layers directly coupled to the clear conductor using microcapsules (FIG. 5) and microcells (FIG. 6). In the embodiments shown, a polyurethane film, i.e., a thermoplastic polyurethane film, is prepared and then coated with a clear conductor, such as sputtered ITO or PEDOT. One film is used as the starting web for coating microcapsules or creating microcells as known in the art. Once the electro-optic layer is complete, i.e., by filling and sealing the microcells, adding additional adhesive layers, etc. the second layer of clear polyurethane layers directly coupled to the clear conductor are added to the other side to produce an optically-switching film that can easily be incorporated into surfaces.

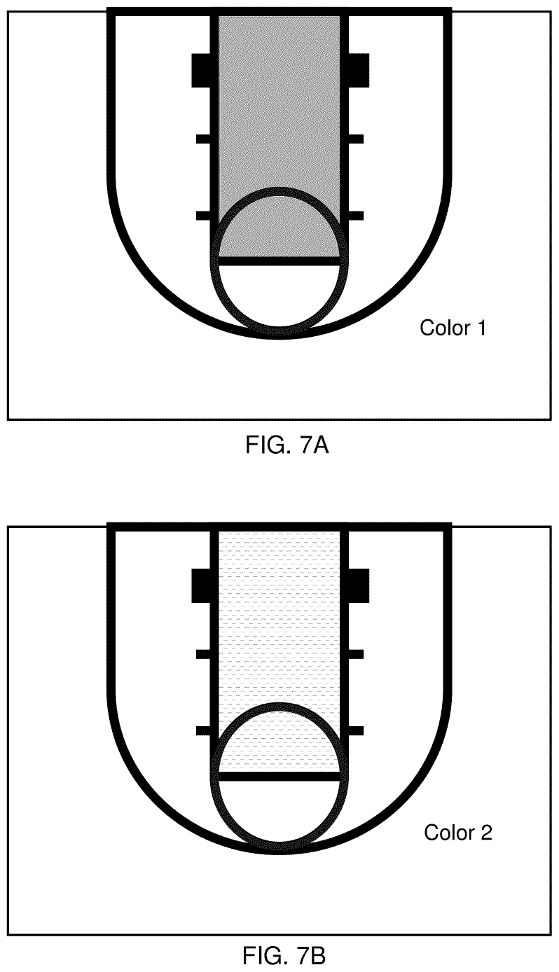

A front plane laminate or display comprising an outer layer of light-transmissive polyurethane can be easily incorporated into everyday objects such as floors, walls, windows, doors, countertops, body panels of a vehicle, windshields/window of a vehicle, or recreational equipment, such as skis, racquets, clubs, surfboards, snowboards, bikes etc. The method of incorporating includes providing a front plane laminate or display comprising an outer layer of light-transmissive polyurethane, affixing the front plane laminate or display comprising an outer layer of light-transmissive polyurethane to the surface wherein the front plane laminate or display comprising an outer layer of light-transmissive polyurethane does not cover the entire surface and coating the surface and the front plane laminate or display comprising an outer layer of light-transmissive polyurethane with a polyurethane. For example, a display comprising an outer layer of light-transmissive polyurethane can be used to “paint” the free throw lane of a basketball court, as shown in FIGS. 7A and 7B. The floor is assembled and prepared as typical, including laying hardwood and painting the various lines. Prior to spraying (or rolling) polyurethane on the court, a display comprising an outer layer of light-transmissive polyurethane is affixed over the free thrown lane and then the entire floor is overcoated with a polyurethane dispersion as is typical for finishing a basketball court. As a result, it is now possible to change the color of the free throw lane between FIGS. 7A and 7B as desired to match, for example a color of the home team. Depending upon the type of electro-optic medium, it may also be possible to provide, e.g., a green background to place virtual images inside the free throw lane during commercials, etc. Because the final overcoat is the same as typically used, the court surface is as durable and resilient as expected. However, the invention substantially decreases the likelihood of delamination while also improving the optical integration of the front plane laminate or display.

The front plane laminates and displays of the invention may be substantially rigid or the materials may be chosen to allow the display to flex. Such a display does not require the type of thick, rigid sealing member found in some prior art displays, and provided the backplane is sufficiently flexible, the peripheral portions of the backplane and barrier sheet, or the two barrier sheets, adhered to each other can remain flexible. In some applications, the entire stack may be light-transmissive except for portions of the electrophoretic medium, i.e., the charged pigment particles. In some embodiments, the electrophoretic medium may include only one type of particle and the display may be designed to provide suitable electric fields to cause the pigment particles to move to a “shutter” state in which the viewing area become substantially light-transmissive.

The electrode arrangements in the various types of displays of the present invention can be of any of the types described in the aforementioned E Ink and MIT patents and applications. Thus, for example, the displays may be of the direct drive type, in which the backplane is provided with a plurality of electrodes, each of which is provided with a separate connector by means of a which a controller can control the voltage applied to the specific electrode. In such a direct drive display, a single continuous front electrode is usually provided covering the whole display, although other front electrode arrangements are possible. Depending upon the type of electro-optic material used, it may be possible to use a passive matrix drive arrangement in which (typically) the backplane carries a plurality of elongate parallel electrodes (“column electrodes”), while on the opposed side of the electro-optic material there is provided a plurality of elongate parallel electrodes (“row electrodes”) running at right angles to the column electrodes, the overlap between one specific column electrode and one specific row electrode defining one pixel of the display. The present displays may also be of the active matrix type, typically with a single continuous front electrode covering the whole display and a matrix of pixel electrodes on the backplane, each pixel electrode defining one pixel of the display and having an associated transistor or other non-linear element, the active matrix display being scanned in the conventional manner to write the display in a row-by-row fashion. Finally, the present display may also be of the stylus-driven type. with (typically) a single electrode on the backplane and no permanent front electrode, writing of the display being affected by moving a stylus across the front surface of the display.

The displays of the present invention may be used in any application in which prior art electro-optic displays have been used. Thus, for example, the present displays may be used in electronic book readers, portable computers, tablet computers, cellular telephones, smart cards, signs, watches, shelf labels and flash drives.

Numerous changes and modifications can be made in the preferred embodiments of the present invention already described without departing from the scope of the invention. Accordingly, the foregoing description is to be construed in an illustrative and not in a limitative sense.

1. A front plane laminate comprising a layer of light-transmissive polyurethane.

2. The front plane laminate of claim 1, comprising in order from top to bottom:
a layer of light-transmissive polyurethane;
a clear conductor;
an electro-optic layer including an electrophoretic medium; and
a substrate.

3. The front plane laminate of claim 2, wherein the front plane laminate further comprises a UV protection barrier between the layer of light-transmissive polyurethane and the clear conductor.

4. The front plane laminate of claim 2, wherein the front plane laminate further comprises a first moisture barrier between the layer of light-transmissive polyurethane and the clear conductor.

5. The front plane laminate of claim 2, wherein the clear conductor comprises indium tin oxide [ITO], poly(3,4-ethylenedioxythiophene) [PEDOT], nanotubes, graphene, metal threads, or metal grid.

6. The front plane laminate of claim 2, wherein the front plane laminate further comprises one or more layers of adhesive between the layer of light-transmissive polyurethane and the substrate.

7. The front plane laminate of claim 1, wherein the layer of light-transmissive polyurethane is a thermoplastic polyurethane (TPU).

8. The front plane laminate of claim 2, wherein the layer of light-transmissive polyurethane is a thermoplastic polyurethane (TPU).

9. The front plane laminate of claim 1, wherein the layer of light-transmissive polyurethane is between 1 mm and 100 μm in thickness.

10. A display comprising, in order from top to bottom:
a layer of light-transmissive polyurethane;
a clear conductor;
an electro-optic layer including an electrophoretic medium;
a second conductor; and
a substrate.

11. The display of claim 10, wherein the substrate comprises a second layer of polyurethane.

12. The display of claim 10, further comprising a backing layer below the substrate.

13. The display of claim 12, wherein the backing layer is coupled to the substrate with a pressure sensitive adhesive to allow the backing layer to be removed from the substrate so that the display can be affixed to a surface.

14. A method of incorporating an electro-optic medium into a surface comprising:
providing a display comprising an outer layer of light-transmissive polyurethane;
affixing the display comprising an outer layer of light-transmissive polyurethane to a surface wherein the display comprising an outer layer of light-transmissive polyurethane does not cover the entire surface; and
coating the surface and the display comprising an outer layer of light-transmissive polyurethane with additional polyurethane.

15. The method of claim 14, wherein the display comprises in order from top to bottom:
an outer layer of light-transmissive polyurethane;
a clear conductor;
an electro-optic layer including an electrophoretic medium;
a conductor; and
a substrate.

16. The display of claim 15, wherein the substrate comprises a second layer of polyurethane.

17. The method of claim 14, wherein the surface comprises a floor, a wall, a window, a door, a countertop, a body panel of a vehicle, or recreational equipment.

18. The method of claim 14, wherein the additional polyurethane is a polyurethane dispersion.

19. The method of claim 18, wherein the method further comprises curing the polyurethane dispersion.

20. The method of claim 18, wherein coating comprises spraying, rolling, or brushing the polyurethane dispersion.
